(19) United States
(12) Patent Application Publication
(10) Pub. No.: US 2007/0074254 A1
(43) Pub. Date: Mar. 29, 2007

(54) Locating content in a television environment

(75) Inventor: David Hendler Sloo, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/236,336

(22) Filed: Sep. 27, 2005

(51) Int. Cl. G06F 13/00; G06F 3/00; H04N 5/445

(52) U.S. Cl. 725/52; 725/53

(57) ABSTRACT

A search query is received in a television environment and a search is requested using the search query. Results of the search are received and at least a portion of the received results are displayed. Filtering instructions are received and the received results are filtered to generate filtered results. At least a portion of the filtered results are displayed.

### BACKGROUND

Users of television systems and other media systems often want to locate a particular television program or other type of media content. As the amount of available content increases, searching for the desired program becomes increasingly difficult and time-consuming. Typical television remote controls make searching for content in a television environment more difficult. These typical television remote controls do not generally have a good mechanism for inputting text characters due to the limited set of input keys. For example, other than the various configuration and television-specific input keys, a typical television remote control may only have a standard numeric or alphanumeric input keypad that includes numbers zero through nine to input data.

Difficulty in searching for program content may affect various individuals and/or entities. For example, a user may become frustrated if they are unable to locate and view the desired content. Additionally, content creators may suffer if their target audience is unable to locate their content. Content aggregators and content distributors may lose revenue if users cannot locate the desired content, especially when the user is searching for pay-per-view or other premium content.

Further, many search results are language specific. However, certain users are interested in content from multiple language sources. Existing systems typically require separate searches for each of the multiple languages of interest or they combine together all languages, ignoring the different input methods or sort orders that are dictated by the individual languages.

Therefore, it would be desirable to provide a system that provides a convenient system to search for specific content using a typical television remote control and further permits searching for content in multiple languages.

### SUMMARY

The systems and methods described herein support searching for media content in a television environment. A search query is received and a search is requested using that search query. Results of the search are received such that the results include programs that match the search query. At least a portion of the received results are displayed in the television environment. Filtering instructions are received, followed by the filtering of the received results based on the received filtering instructions. Filtering of the received results generates filtered results. At least a portion of the filtered results are displayed in the television environment.

In a particular embodiment, the filtering of the received results prevents displaying of programs that are not associated with a particular language.

### BRIEF DESCRIPTION OF THE DRAWINGS

Similar reference numbers are used throughout the figures to reference like components and/or features.

FIG. 1 illustrates an example system that allows a television user to search for specific content.

FIG. 2 is a flow diagram illustrating an embodiment of a procedure for receiving search input and displaying corresponding search results.

FIG. 3 illustrates an example media descriptor.

FIGS. 4A-4D illustrate an example user interface displaying search results as a user searches for specific content in a television environment.

FIG. 5 illustrates various components of an example client device in which the systems and methods discussed herein can be implemented.

FIG. 6 illustrates various devices and components in an example entertainment and information system in which the systems and methods discussed herein can be implemented.

### DETAILED DESCRIPTION

The systems and methods described herein support searching for and displaying data in a television environment. These systems and methods permit efficient searching using a typical television remote control and further permit searching for content in multiple languages. Users are able to refine the initial search results by filtering the results based on various criteria. This filtering is performed without changing the search query and without requiring a subsequent search. Different filtering instructions can be applied to the same set of search results to display different portions of the search results. The systems and methods described herein provide a common user interface for locating content using any number of different searching techniques, such as searching by title, keyword, language, and the like.

Particular examples discussed herein refer to specific components in a television environment. A television environment includes any one or more systems or methods related to, for example, processing video data, image data, audio data, program guide data, or other entertainment-related data. However, the systems and methods discussed herein may be utilized with other components contained in similar or different operating environments.

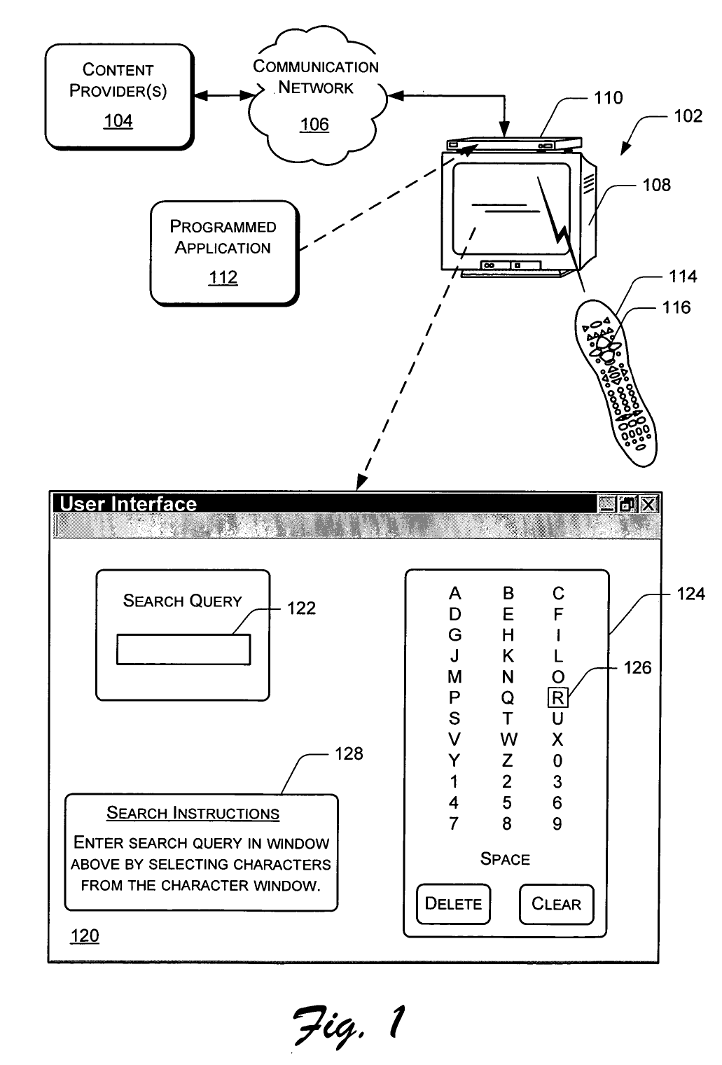

FIG. 1 illustrates an example system 100 that allows a television user to search for specific content. In this example, the system 100 includes a television-based client system 102 configured for data communication with any number of content provider(s) 104 via a communication network 106, which in this example, is an Internet Protocol (IP)-based network. The embodiments described herein can also be implemented in any television-based system using any type of content distribution mechanism. The client system 102 receives program content, various forms of media content, television programs, movies, program guide data, advertising content, audio content, games, and the like from content server(s) of the content provider(s) 104 via the communication network 106. Content provider(s) 104 may access content from any number of data sources.

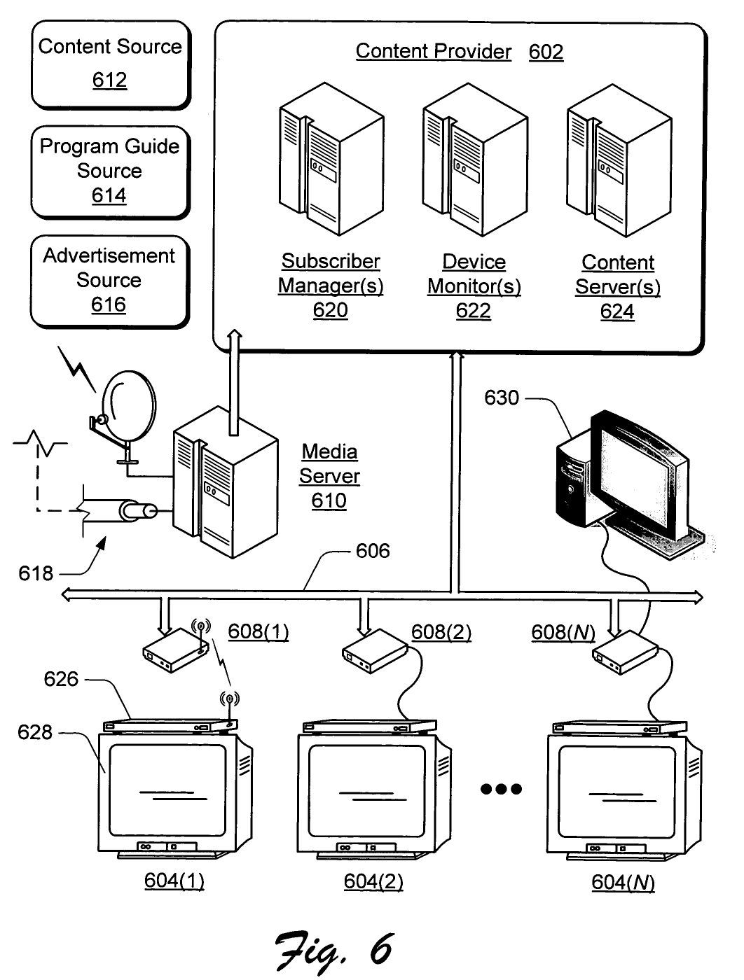

The television-based client system 102 includes a display device 108 (e.g., a television, LCD display, or the like) and a client device 110. Client device 110 can be implemented in any number of embodiments, such as a set-top box, a digital video recorder (DVR) and playback system, a personal video recorder (PVR), an appliance device, a gaming system, any combination thereof, and as any other type of client device that may be implemented in a television-based entertainment and information system. In one embodiment, the client device 110 can be implemented with any one or combination of the components described with reference to client device 500 shown in FIG. 5. Further, any combination of the components described with reference to system 100 can be implemented in the example television-based system 600 that includes examples of both a network-based content provider and television-based client devices as described with reference to FIG. 6.

In the example of FIG. 1, client device 110 includes a programmed application 112 that can be programmed to implement the various features and embodiments described herein. Although the programmed application 112 is illustrated and described as a single application, the programmed application 112 can be implemented as several component applications distributed to each perform one or more functions in client device 110.

A user can input television commands, a sequence of characters, and the like with an input device, such as television remote control 114 that has various keys 116. Example keys 116 include search and navigation keys that allow a user to select characters or information by navigating a pointer to the desired character or information and selecting the desired information by activating a “select” key. Alternatively, a user may enter characters or commands to client device 110 with a cellular phone, PDA, or other input device that can be configured to operate as a television remote control device.

A user interface 120 is displayed on the display device 108 to facilitate, for example, a user searching for program content. In this example, the user interface 120 includes a search query box 122, a character selection box 124, and a message box 128. Search query box 122 displays the sequence of characters input by a user when entering a search term with an input device, such as television remote control 114. In this example, the character selection box 124 displays an alphabetic listing of the letters of the alphabet as well as numerals zero (0) through nine (9). Character selection box 124 also includes selections for entering a space, deleting a character, and clearing search query box 122. A selection indicator 126 identifies a currently selected character (“R” in this example). A user can navigate the position of selection indicator 126 by activating one or more keys on television remote control 114. A currently selected character can be selected (e.g., added to search query box 122) by activating an appropriate selection key on television remote control 114. In the example of FIG. 1, message box 128 displays a message that provides instructions for entering a search query in search query box 122.

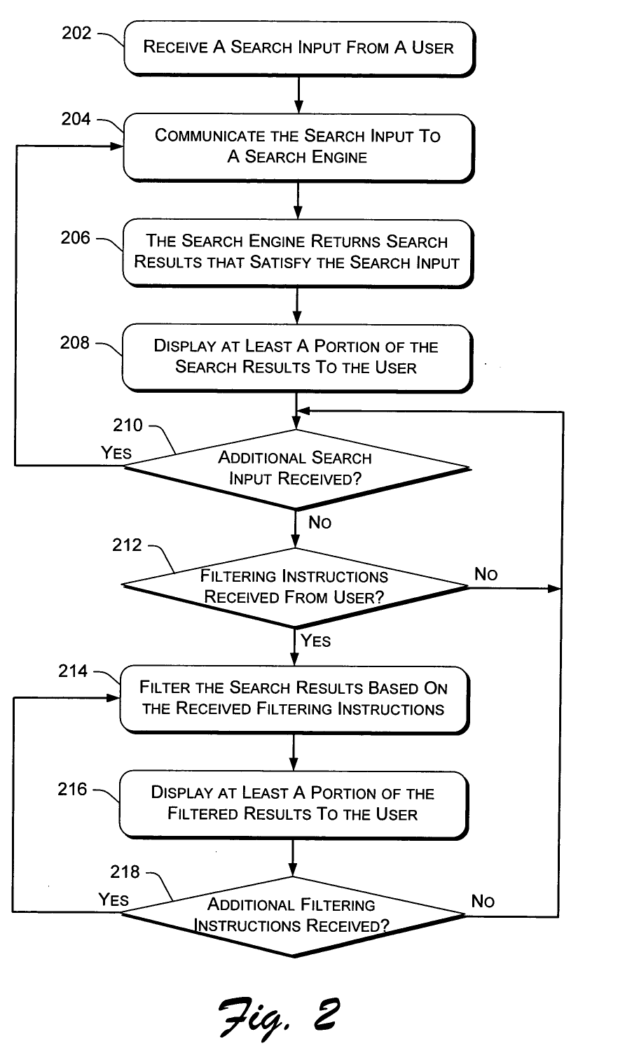

FIG. 2 is a flow diagram illustrating an embodiment of a procedure 200 for receiving search input and displaying corresponding search results. Procedure 200 may be performed, for example, by a client device such as client device 110 shown in FIG. 1. Initially, a search input is received from a user (block 202), such as a television viewer or other user of the client device. For example, the search input may be a single character or a series of two or more characters. Procedure 200 continues by communicating the received search input to a search engine (block 204). In one embodiment, the search engine is hosted by a content provider. In other embodiments, the search engine can be located in any device or system that is capable of communicating with the client device. In a particular embodiment, the search engine is located within the client device.

The search engine performs a content search based on the search input and returns search results that satisfy the search input (block 206). The client device then displays at least a portion of the search results to the user (block 208), e.g., via display device 108 shown in FIG. 1. If the client device is unable to display all of the search results on the display device simultaneously (e.g., due to the size of the display device), the client device initially displays a portion of the search results. The user can then scroll or navigate through the entire set of search results. Alternatively, the user may modify the search input and perform a new search, or the user may filter the search results as discussed below.

If additional search input is received from the user (e.g., modifying the original search input), the procedure returns to block 204 to communicate the new search input to the search engine for processing. Otherwise, the procedure continues by determining whether filtering instructions have been received from the user (block 212). If no filtering instructions have been received, the procedure returns to block 210 to check for additional search input. If the user has provided filtering instructions at bock 212, the procedure continues to block 214 where the search results are filtered based on the received filtering instructions. Procedure 200 continues by displaying at least a portion of the filtered results to the user (block 216). As discussed above, if the client device is unable to display all of the filtered results on the display device simultaneously (e.g., due to the size of the display device), the client device initially displays a portion of the filtered results. The user can then scroll or navigate through the entire set of filtered results. Alternatively, the user may modify the filtering instructions to change the filtered results.

After displaying at least a portion of the filtered results to the user, the procedure determines whether additional filtering instructions have been received from the user (block 218). For example, the user may add one or more additional filtering instructions or modify the original filtering instructions. If additional filtering instructions have been received, the procedure returns to block 214 to filter the search results based on the new filtering instructions. Otherwise, the procedure returns to block 210 to check for additional search input.

The procedure illustrated in FIG. 2 allows the user to change filter criteria to locate the desired content without requiring the user to initiate a new search query. This procedure may allow a user to locate desired content in a faster, more efficient manner.

Each media asset (e.g., a television program, a movie, an audio recording, and the like) available from a content provider or other source has an associated media descriptor. A media descriptor contains various metadata associated with the media asset that help to identify and characterize the media asset. The media descriptor contains a field for each type of metadata. Multiple media descriptors may be stored in a “dictionary” that is searchable by a search engine or other system. When creating a searchable dictionary, it is useful to eliminate the most common element matches to increase the effectiveness of the query. For example, with title queries terms such as “a”, “the”, and “of” are vague, would generate a large number of matches, and are not likely to be specifically searched for by a user.

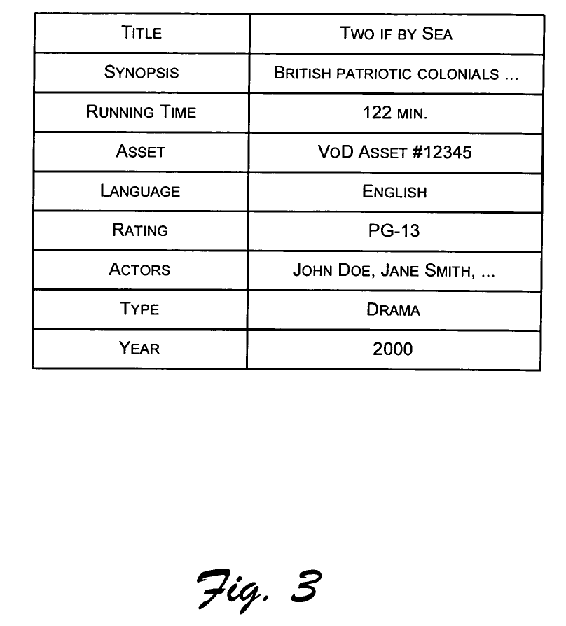

FIG. 3 illustrates an example media descriptor 300. Media descriptor 300 can be considered a multi-field database record. In this example, media descriptor 300 includes various categories of information in the left column and corresponding values associated with each category in the right column. For example, a “Title” category has a corresponding value of “Two if by Sea” and a “Rating” category has a corresponding value of “PG-13”. When a query is made of one or more categories, all media descriptors matching the query are returned. FIG. 3 represents one example of media descriptor 300. Alternate embodiments may contain any number of categories and corresponding values, and may contain any number of values associated with each category. Various types of dictionary lookup techniques can be used to identify appropriate media descriptors 300. In a particular embodiment, a dictionary can be pre-constructed for any corpus and any set of known input strings.

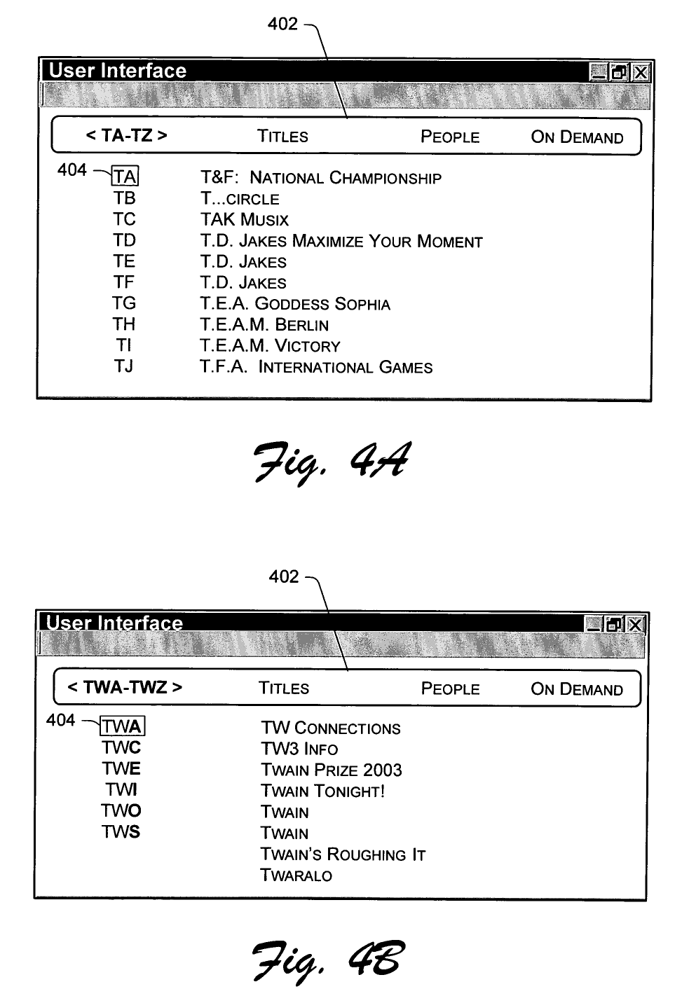

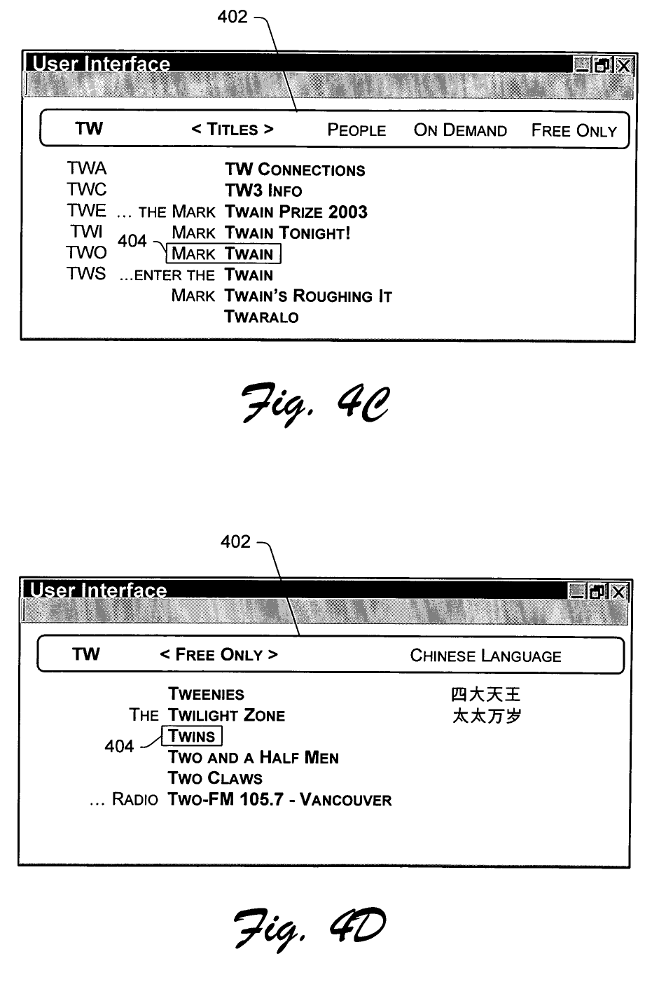

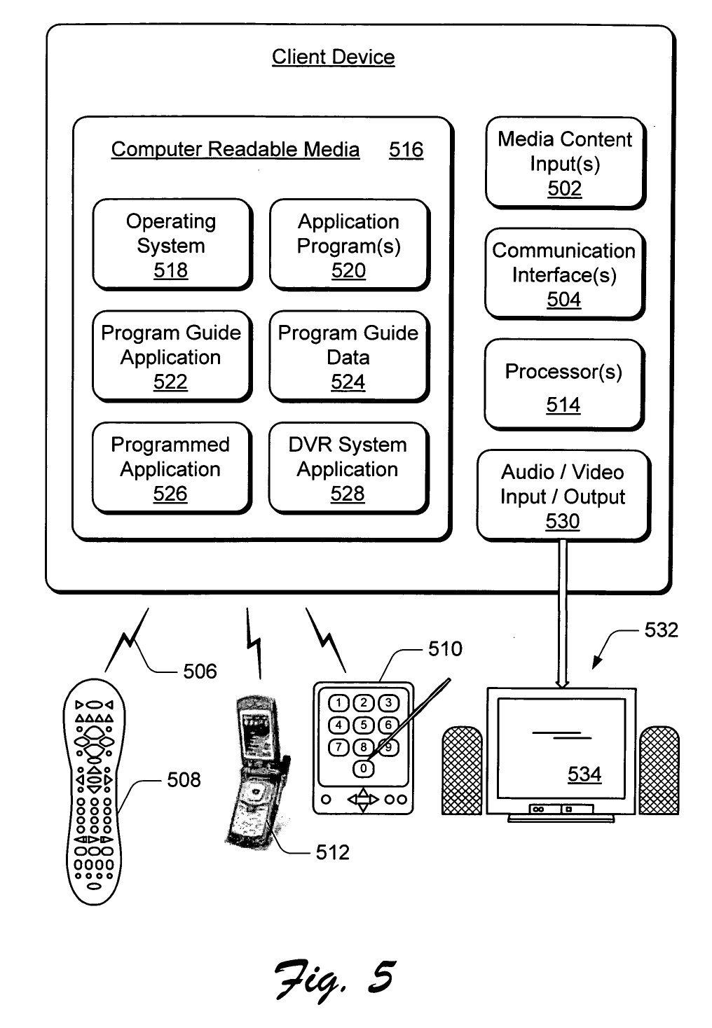

FIGS. 4A-4D illustrate an example user interface 400 displaying search results as a user searches for specific content in a television environment. FIG. 4A illustrates an initial display of search results after a user has entered the letter “t” as a search query. In FIG. 4A, user interface 400 includes a menu bar 402 that contains various filtering options available to the user. For example, the menu bar in FIG. 4A includes “Titles”, “People” and “On Demand”. “Titles” displays search results based on program titles in alphabetical order. The “People” filter displays search results based on actors, actresses, directors, and the like. The “On Demand” filter displays content that is associated with, for example, a video-on-demand library, which stores multiple television programs for viewing at any time that the viewer prefers. In general, on-demand content is not tied to a particular time schedule and, instead, can be accessed by a viewer at any time.

In FIG. 4A, the “<TA-TZ>” item in menu bar 402 is highlighted (e.g., shown in bold) to indicate that it is the active item in the menu bar. The identifier “TA-TZ” indicates a range of values that the user can select from. In this example, choices TA, TB, TC, TD, TE, TF, TG and TH are currently displayed. The user could scroll down the list to display other choices. Alternatively, the user could use the television remote control to enter another character, which would be appended to the search query.

As shown in FIG. 4A, a cursor 404 is currently highlighting entry TA, which is the first entry in the list “TA-TZ”. Selection of entry TA causes the list of titles displayed in user interface 400 to include the first titles contained in the search results.

FIG. 4B illustrates user interface 400 after a user has either selected “TW” from the listing shown in FIG. 4A or added a second letter (W) to the search query. User interface 400 now displays the titles of search results that begin with the letters “tw”. Cursor 404 is highlighting entry “TWA”, so the titles include the first entries in the search results starting with letters “tw”. Additionally, the items in menu bar 402 have been updated to identify the new range of values “TWA-TWZ”.

FIG. 4C illustrates user interface 400 after the user has selected “Titles” in menu bar 402. An additional entry “Free Only” has been added to menu bar 402. The “Free Only” filter displays search results that are free to view (e.g., not pay-per-view or other content having an associated fee).

FIG. 4D illustrates user interface 400 after the user has selected “Free Only” in menu bar 402. In this example, several of the titles shown in FIG. 4C starting with “tw” are not shown in FIG. 4D because they were not free programs. Menu bar 402 contains a different entry “Chinese Language”, which filters the search results to include Chinese search results that match the “tw” input.

As discussed herein, instead of having a single test that is applied to every media descriptor, the search algorithm used can be determined by each media descriptor. Thus, for a particular search query, the criteria used to see if a particular media descriptor is included in the search results will change depending on the nature of the description. In the example above, the significance of the “tw” input changes depending on the language of the particular asset represented. If the asset is a Roman-character-titled program, then “matching” means that the media descriptor contains a word that starts with the input characters. In the above example, a word in the title would have to begin with the letters “tw” to match. In contrast, if the asset is a Chinese-language-titled program, then “matching” means that the media descriptor contains consecutive characters whose pronunciation is represented by pinyin syllables that begin with the consecutive characters. Pinyin is a system for transliterating Chinese ideograms into the Roman alphabet. In the above example, a matching title would have to contain two consecutive characters with pinyin pronunciations beginning “t” and then “w”. An example pinyin phrase satisfying this search is “tai wan”. Thus, two different algorithms may be used: one for pure Roman titles and another for Chinese titles with accompanying pinyin pronunciations. In alternate embodiments, any number of different algorithms may be used when identifying appropriate search results.

Other types of algorithms that can be used when identifying appropriate search results include algorithms that analyze pronunciations to identify user-entered misspellings. For example, if an actor's first name is entered by the user as “John”, but the media descriptor accurately identifies the actor's first name as “Jon”, the algorithm can account for this mistake.

As mentioned above, a user can filter search results by using various filter instructions (e.g., selecting a particular filter in title bar 402). When a user first enters a search query, the user may not know how many results will be generated by the search query. However, after the user has an opportunity to view the search results, they are in a better position to refine the search by either re-entering the search query or filtering the existing search results.

The systems and methods discussed herein provide a “two-axis” user interface. The first axis contains the displayed listing of the search results. For example, the first axis is the vertical axis when the search results are displayed in a vertical manner (as shown in FIG. 4). The second axis contains the various filters that can be applied to the search results. These filters may represent different attributes associated with one or more of the items listed in the search results. In the example of FIG. 4, these filters are displayed in a horizontal manner. Thus, the vertical axis contains the search results and the horizontal axis contains the available filters. The user navigates the vertical and horizontal axes to locate the desired content.

In one embodiment, the client device applies a particular filter to the search results when the user selects the particular filter. In other embodiments, the search engine (or other search service) provides multiple pre-filtered lists of media descriptors that satisfy the search query.

In the examples discussed above, media content was searched and filtered based on characteristics of the content title. However, media content can be searched and filtered on a variety of different characteristics. For example, a user may input a an actor or actress name, which generates search results that identify media content in which that actor or actress was involved. Alternatively, the user may input a photo of the actor or actress to generate similar search results. In this situation, a face-matching algorithm would be applied to the input photo to locate other photos with similar facial geometry.

In another example, if a particular actor name is used to generate the search results, that actor's birth country may be used as a filter to find other actors born in the same country. Other examples of input data include graphical data, multiple actor or actress names, movie poster, program ratings, program genre, subtitle availability, high definition content, and the like.

FIG. 5 illustrates various components of an exemplary client device 500 which can be implemented as any form of a computing, electronic, and/or television-based client device, and in which the systems and methods discussed herein can be implemented. For example, the client device 500 can be implemented as the television-based client device 110 shown in FIG. 1 as part of the television-based client system 102.

Client device 500 includes one or more media content inputs 502 which may include Internet Protocol (IP) inputs over which streams of media content are received via an IP-based network. Device 500 further includes communication interface(s) 504 which can be implemented as any one or more of a serial and/or parallel interface, a wireless interface, any type of network interface, a modem, and as any other type of communication interface. A wireless interface enables client device 500 to receive control input commands 506 and other information from an input device, such as from remote control device 508, PDA (personal digital assistant) 510, cellular phone 512, or from another infrared (IR), 802.11, Bluetooth, or similar RF input device.

A network interface provides a connection between the client device 500 and a communication network by which other electronic and computing devices can communicate data with device 500. Similarly, a serial and/or parallel interface provides for data communication directly between client device 500 and the other electronic or computing devices. A modem facilitates client device 500 communication with other electronic and computing devices via a conventional telephone line, a DSL connection, cable, and/or other type of connection.

Client device 500 also includes one or more processors 514 (e.g., any of microprocessors, controllers, and the like) which process various computer executable instructions to control the operation of device 500, to communicate ith other electronic and computing devices, and to implement the embodiments described herein. Client device 500 can be implemented with computer readable media 516, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 516 provides data storage mechanisms to store various information and/or data such as software applications and any other types of information and data related to operational aspects of client device 500. For example, an operating system 518 and/or other application programs 520 can be maintained as software applications with the computer readable media 516 and executed on processor(s) 514 to implement the systems and methods discussed herein.

For example, client device 500 can be implemented to include a program guide application 522 that is implemented to process program guide data 524 and generate program guides for display which enable a viewer to navigate through an onscreen display and locate broadcast programs, recorded programs, video on-demand programs and movies, interactive game selections, network-based applications, and other media access information or content of interest to the viewer. The computer readable media 516 can also include a programmed application 526 to implement features and embodiments described herein. The computer readable media 516 can also include a DVR system application 528 to maintain and playback recorded media content.

Although the programmed application 526 is illustrated and described as a single application configured to implement embodiments described herein, the programmed application 526 can be implemented as several component applications distributed to each perform one or more functions in a client device in a television-based entertainment and information system. Further, the program guide application 522 may include the programmed application 526 as an integrated module or component.

The client device 500 also includes an audio and/or video output 530 that provides audio and video to an audio rendering and/or display system 532, or to other devices that process, display, and/or otherwise render audio, video, and display data. Video signals and audio signals can be communicated from device 500 to a television 534 (or to other types of display devices) via an RF (radio frequency) link, S-video link, composite video link, component video link, analog audio connection, or other similar communication link.

FIG. 6 illustrates an exemplary entertainment and information system 600 in which an IP-based television environment can be implemented, and in which embodiments discussed herein can be implemented. System 600 facilitates the distribution of program content, program guide data, and advertising content to multiple viewers. System 600 includes a content provider 602 and television-based client systems 604(1-N) each configured for communication via an IP-based network 606.

The network 606 can be implemented as a wide area network (e.g., the Internet), an intranet, a Digital Subscriber Line (DSL) network infrastructure, or as a point-to-point coupling infrastructure. Additionally, network 606 can be implemented using any type of network topology and any network communication protocol, and can be represented or otherwise implemented as a combination of two or more networks. A digital network can include various hardwired and/or wireless links 608(1-N), routers, gateways, and so on to facilitate communication between content provider 602 and the client systems 604(1-N). The television-based client systems 604(1-N) receive program content, program guide data, advertising content, closed captions data, and the like from content server(s) of the content provider 602 via the IP-based network 606.

System 600 includes a media server 610 that receives program content from a content source 612, program guide data from a program guide source 614, and advertising content from an advertisement source 616. In an embodiment, the media server 610 represents an acquisition server that receives the audio and video program content from content source 612, an EPG server that receives the program guide data from program guide source 614, and/or an advertising management server that receives the advertising content from the advertisement source 616.

The content source 612, the program guide source 614, and the advertisement source 616 control distribution of the program content, the program guide data, and the advertising content to the media server 610 and/or to other television-based servers. The program content, program guide data, and advertising content is distributed via various transmission media 618, such as satellite transmission, radio frequency transmission, cable transmission, and/or via any number of other wired or wireless transmission media. In this example, media server 610 is shown as an independent component of system 600 that communicates the program content, program guide data, and advertising content to content provider 602. In an alternate implementation, media server 610 can be implemented as a component of content provider 602.

Content provider 602 is representative of a headend service in a television-based content distribution system, for example, that provides the program content, program guide data, and advertising content to multiple subscribers (e.g., the television-based client systems 604(1-N)). The content provider 602 can be implemented as a satellite operator, a network television operator, a cable operator, and the like to control distribution of program and advertising content, such as movies, television programs, commercials, music, and other audio, video, and/or image content to the client systems 604(1-N).

Content provider 602 includes various components to facilitate media data processing and content distribution, such as a subscriber manager 620, a device monitor 622, and a content server 624. The subscriber manager 620 manages subscriber data, and the device monitor 622 monitors the client systems 604(1-N) (e.g., and the subscribers), and maintains monitored client state information.

Although the various managers, servers, and monitors of content provider 1602 (to include the media server 610 in one embodiment) are illustrated and described as distributed, independent components of content provider 602, any one or more of the managers, servers, and monitors can be implemented together as a multi-functional component of content provider 602. Additionally, any one or more of the managers, servers, and monitors described with reference to system 600 can implement the features and embodiments discussed herein.

The television-based client systems 604(1-N) can be implemented to include a client device 626 and a display device 628 (e.g., a television). A client device 626 of a television-based client system 604 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 604(N) is implemented with a computing device 630 as well as a client device 626. Additionally, any of the client devices 626 of a client system 604 can implement the features and embodiments described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a search query in a television environment;
requesting a search using the received search query;
receiving results of the search, wherein the results of the search include programs that match the search query;
displaying at least a portion of the received results;
receiving filtering instructions;
filtering the received results to generate filtered results, wherein the filtering is based on the received filtering instructions; and
displaying at least a portion of the filtered results.

2. A method as recited in claim 1 wherein filtering the received results is performed without altering the search results.

3. A method as recited in claim 1 wherein filtering the received results prevents displaying of programs that do not have a particular associated language.

4. A method as recited in claim 1 wherein the filtering the received results prevents displaying of programs that are not associated with a particular program category.

5. A method as recited in claim 1 wherein filtering the received results prevents displaying of programs that are not associated with a particular actor.

6. A method as recited in claim 1 further comprising:
receiving additional filtering instructions;
filtering the received results based on the additional filtering instructions to generate second filtered results; and
displaying at least a portion of the second filtered results.

7. A method as recited in claim 1 further comprising displaying an indicator to identify the current filter being applied to the search results.

8. A method as recited in claim 1 wherein receiving results of the search includes:
receiving a first set of search results that are pre-filtered according to a first filter criteria; and
receiving a second set of search results that are pre-filtered according to a second filter criteria.

9. A method as recited in claim 1 wherein the filtered results are displayed along a first axis and a plurality of filtering instructions are displayed along a second axis.

10. One or more computer-readable memories containing a computer program that is executable by a processor to perform the method recited in claim 1.

11. A method comprising:
receiving a listing of television programs in response to a search request, wherein the listing of television programs includes television programs having different associated languages;
displaying at least a portion of the television programs in the received listing;
receiving a request to display television programs having a specific associated language;
filtering the television programs in the received listing to generate filtered results that include television programs having the specific associated language; and
displaying at least a portion of the filtered results.

12. A method as recited in claim 11 wherein filtering the television programs in the received listing is performed without altering the search request.

13. A method as recited in claim 11 further comprising:
receiving additional filtering instructions;
filtering the television programs in the received listing based on the additional filtering instructions to generate second filtered results; and
displaying at least a portion of the filtered results.

14. A method as recited in claim 11 further comprising displaying an indicator to identify a current language filter being applied.

15. A method as recited in claim 11 wherein receiving a listing of television programs in response to a search request includes:
receiving a first set of television programs associated with a first language; and
receiving a second set of television programs associated with a second language.

16. A method as recited in claim 11 wherein the filtered results are displayed along a first axis and additional language filtering instructions are displayed along a second axis.

17. One or more computer-readable memories containing a computer program that is executable by a processor to perform the method recited in claim 11.

18. One or more computer readable media having stored thereon a plurality of instructions that, when executed by one or more processors, causes the one or more processors to:
receive a listing of television programs, wherein the listing of television programs includes television programs associated with a first language and television programs associated with a second language;
display television programs associated with the first language;
receive a request to display television programs associated with the second language;
identify characteristics of the second language;
filter the listing of television programs based on the characteristics of the second language to identify television programs associated with the second language; and
display at least a portion of the television programs associated with the second language.

19. One or more computer readable media as recited in claim 18, wherein the one or more processors:
receive the listing of television programs in response to a search request; and
filter the listing of television programs without performing another search request.

20. One or more computer readable media as recited in claim 18, wherein the one or more processors further display an indicator to identify that programs associated with the second language are being displayed.
